(19) United States
(12) Patent Application Publication
(10) Pub. No.: US 2014/0157399 A1
(43) Pub. Date: Jun. 5, 2014

(54) INFORMATION PROCESSING APPARATUS, AUTHENTICATION METHOD FOR INFORMATION PROCESSING APPARATUS AND AUTHENTICATION PROGRAM FOR INFORMATION PROCESSING APPARATUS

(71) Applicant: Kabushiki Kaisha Toshiba, Tokyo (JP)

(72) Inventor: Koji Yamamoto, Tokyo (JP)

(73) Assignee: KABUSHIKI KAISHA TOSHIBA, Tokyo (JP)

(21) Appl. No.: 14/032,120

(22) Filed: Sep. 19, 2013

(30) Foreign Application Priority Data
Nov. 30, 2012 (JP) 2012-263069

(51) Int. Cl. G06F 21/30

(52) U.S. Cl. CPC G06F 21/30
USPC 726/16

(57) ABSTRACT

One embodiment provides an information processing apparatus equipped with a housing having a first surface and a second surface opposite thereto and with a touch screen provided on the first surface of the housing. The information processing apparatus has a first operation receiver and an authentication processor. The first operation receiver is provided on the second surface of the housing. And, the authentication processor performs an authentication process based on operation of the first operation receiver.

### CROSS-REFERENCE TO RELATED APPLICATION(S)

This application claims priority/priorities from Japanese Patent Application No. 2012-263069 filed on Nov. 30, 2012, the entire contents of which are incorporated herein by reference.

### FIELD

Embodiments described herein relate generally to an information processing apparatus, an authentication method for the information processing apparatus and an authentication program for the information processing apparatus.

### BACKGROUND

A portable information processing apparatus such as a smartphone, a tablet apparatus, etc. is widely used. Such information processing apparatus is often provided with a touch screen which has a touch panel laminated on a display screen to enable a touch operation on the display screen.

In the information processing apparatus provided with such a touch screen, the touch screen is provided on a front surface of a housing while various mechanical/electrical switches are also provided on the front surface around the touch screen and on side surfaces of the housing. For example, a power switch for making powering-on or canceling sleep may be disposed on a side surface or the like.

This type of information processing apparatus uses various methods as unlock methods at startup. For example, the simplest unlock method is a method of performing a swiping operation on the touch screen after powering on the apparatus or canceling sleep of the apparatus. Or a method of drawing a predetermined shape by a sliding operation on the touch screen to thereby perform authentication and unlocking may be used. Or a method of inputting a personal identification number or the like by a key input operation to thereby perform authentication and unlocking may be used.

Since such information processing apparatus is so lightweight and thin as to be excellent in portability, it will be often used in a place such as a public place where there are other people nearby. For this reason, other people may easily peep at the touch screen and the key operation receiver at the time of authentication operation.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is schematic view showing an information processing apparatus according to a first embodiment.

FIGS. 2A and 2B are schematic front and rear views of the information processing apparatus shown in FIG. 1.

FIG. 3 is a block diagram showing circuit blocks of the information processing apparatus.

FIG. 4 is a flow chart for explaining operation of the first embodiment.

FIG. 5 is a block diagram showing a second embodiment.

FIG. 6 is a flow chart for explaining operation of the second embodiment.

FIGS. 7A to 7C are schematic views showing a third embodiment.

### DETAILED DESCRIPTION

One embodiment provides an information processing apparatus equipped with a housing having a first surface and a second surface opposite thereto and with a touch screen provided on the first surface of the housing. The information processing apparatus has a first operation receiver and an authentication processor. The first operation receiver is provided on the second surface of the housing. And, the authentication processor performs an authentication process based on operation of the first operation receiver.

Embodiments will be described below in detail with reference to the drawings.

### First Embodiment

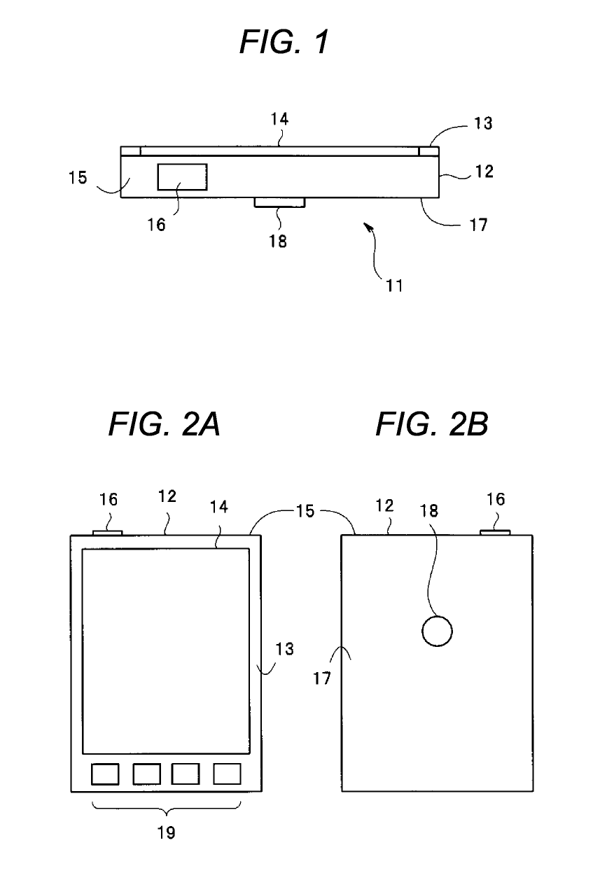

FIG. 1 is a schematic view showing an information processing apparatus according to a first embodiment. FIG. 1 shows external appearance of the information processing apparatus viewed from above. FIGS. 2A and 2B are schematic front and rear views showing a housing of the information processing apparatus shown in FIG. 1. That is, FIG. 2A is a front view showing a front surface of the housing, and FIG. 2B is a rear view showing a rear surface of the housing.

In FIG. 1 and FIGS. 2A and 2B, the information processing apparatus 11 can be used as an information terminal such as a smartphone, a tablet apparatus, etc. The information processing apparatus 11 has a thin housing 12. A touch screen 14 is disposed on a front surface 13 side of the housing 12. A plurality of front operation receivers 19 are provided below the touch screen 14 in the front surface 13 of the housing 12. A top operation receiver 16 is disposed in a top surface 15 of the housing 12. A rear operation receiver 18 is disposed in a rear surface 17 of the housing 12.

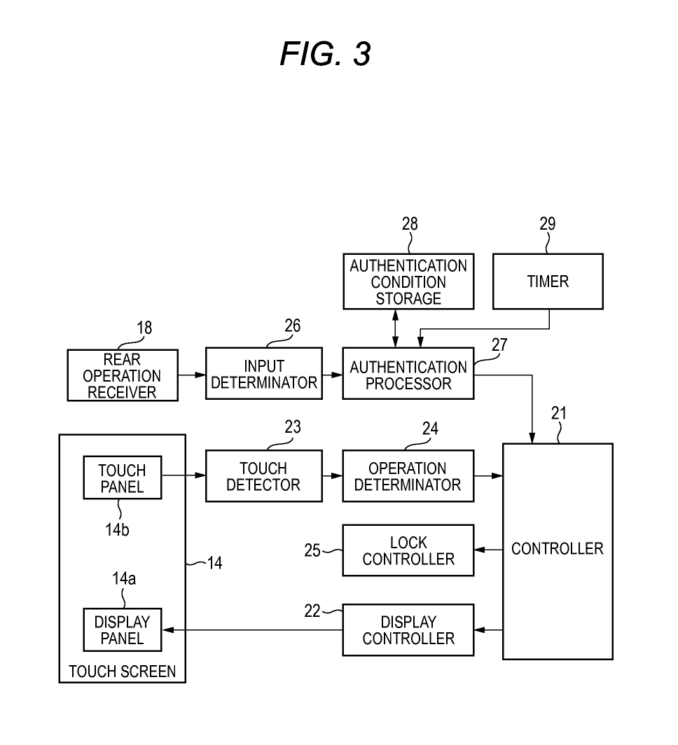

FIG. 3 is a block diagram showing circuit blocks of the information processing apparatus 11.

The touch screen 14 is formed so that a touch panel 14b is laminated on a display screen of a display panel 14a. A liquid crystal panel, an organic EL panel or the like can be used as the display panel 14a. Various type panels such as a resistive type panel, a capacitive type panel, etc. can be used as the touch panel 14b.

A display controller 22 is controlled by a controller 21 to execute various processes concerned with display. For example, the display controller 22 is controlled by the controller 21 so that the display controller 22 can perform various kinds of display such as display of various menus or user interfaces, display of a software keyboard, display of a touch position of touch operation or a locus of slide operation, display based on various applications, display based on video taken by a not-shown camera or stored video data, etc.

The touch panel 14b is designed to output coordinate information of touch or slide operation to a touch detector 23. The touch detector 23 detects user's touch operation based on the coordinate information given from the touch panel 14b and outputs a result of the detection to an operation determinator 24.

The operation determinator 24 determines user's touch operation by referring to a touch operation determination table stored in a not-shown memory, and outputs a result of the operation determination to the controller 21. The controller 21 manages to control the information processing apparatus 11 as a whole, so that the controller 21 can perform control in accordance with the user's touch operation.

For example, the controller 21 can control the display controller 22 to display a software keyboard on the display screen of the display panel 14a. In this case, when the user touches the touch panel 14b, the operation determinator 24 determines key operation in a touch position based on coordinate information of the touch position and feeds code information corresponding to the key to the controller 21.

For example, the controller 21 can control the display controller 22 to perform display corresponding to user's slide operation on the display screen of the display panel 14a. In this case, when the user performs slide operation on the touch panel 14b, the operation determinator 24 determines user's slide operation in a slide position on the display screen based on coordinate information of the position and feeds information corresponding to the slide operation to the controller 21.

A lock controller 25 is controlled by the controller 21 so that part of operation of the operation determinator 24 and the display controller 22 can be subjected to lock control. For example, when there is no operation performed for a predetermined time in a viewpoint of power saving, security, etc. after powering on or when display-off operation or sleep operation is performed on the top operation receiver 16, the controller 21 controls the lock controller 25 to set a locked state where, for example, screen display is turned off and operation on the touch screen 14 is not accepted.

Unlock operation of the lock controller 25 enables the operation determinator 24 and the display controller 22 to operate entirely. The lock controller 25 may perform not only locking part of operation of the operation determinator 24 and the display controller 22 but also lock control and unlocking on other operation receivers provided in the information processing apparatus 11.

In this embodiment, the rear operation receiver 18 is provided for an authentication process prior to the unlock operation of the lock controller 25. For example, the rear operation receiver 18 is made of a button switch which outputs a signal corresponding to user's pushing operation to an input determinator 26. The rear operation receiver 18 is provided in the rear surface 17 of the housing 12. For example, in a state where the user holds the housing 12 in hands with the display screen of the touch screen 14 turned face up, it is thought of that the rear operation receiver 18 can extremely hardly be viewed. The example shown in FIG. 1 assumes that the housing 12 is of a smartphone size so that the user can hold the housing 12 in one hand. When the user holds the housing 12, the rear operation receiver 18 is hidden behind the user's hand and can hardly be viewed. The rear operation receiver 18 may be disposed in a position near the user's hands or fingers when the user holds the housing 12. In this manner, the user can operate the rear operation receiver 18 easily without large movement of the user's hands or fingers and so as not to be noticed by other people.

The input determinator 26 determines whether there is any operation on the rear operation receiver 18 or not, and outputs a result of the determination to an authentication processor 27. An authentication condition storage 28 holds a preset authentication condition having described contents of operation of the rear operation receiver 18 in order to authenticate the user. The authentication processor 27 performs authentication by referring to the authentication condition stored in the authentication condition storage 28 and time information given from a timer 29 and comparing the operation defined in the authentication condition with a result of determination of operation of the rear operation receiver 18. The authentication condition may be formed so as to be able to be set by the user.

For example, when the user pushes down the rear operation receiver 18 once, an authentication condition to authenticate the user may be registered in the authentication condition storage 28. When the user pushes down the rear operation receiver 18 a predetermined number of times continuously in a predetermined time, an authentication condition to authenticate the user may be registered in the authentication condition storage 28. Further, an authentication condition to authenticate the user may be registered in accordance with pushing operation complicated with respect to time and the number of times.

The authentication processor 27 accepts authentication when the authentication operation of the rear operation receiver 18 coincides with the operation defined in the authentication condition.

The authentication processor 27 is designed to output a result of the authentication to the controller 21. Upon reception of the authentication result indicating that the user has been authenticated from the authentication processor 27 in a lock control state, the controller 21 controls the lock controller 25 to set unlocking.

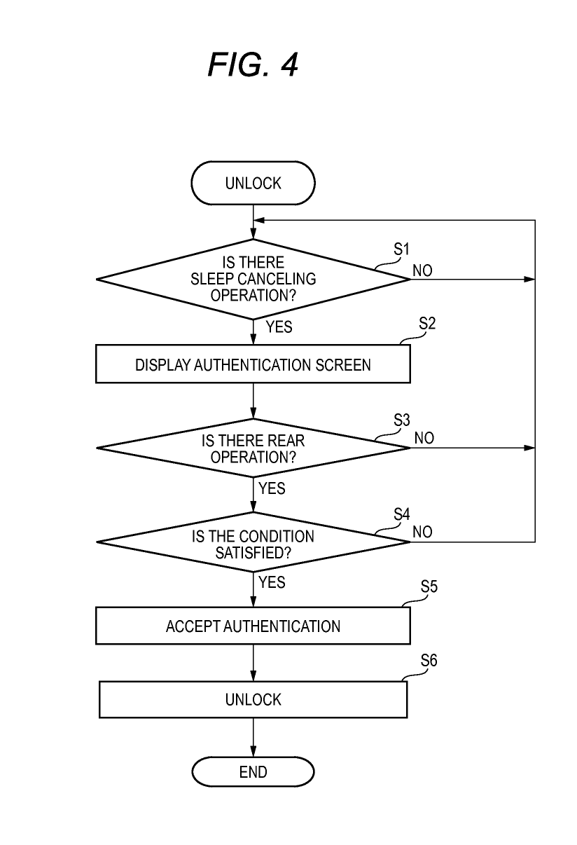

The embodiment configured thus will be described below with reference to a flow chart of FIG. 4.

Assume now that display-off operation is performed after powering on. In this case, for example, the controller 21 proceeds to a sleep mode and controls the lock controller 25 to set a locked state. For example, the lock controller 25 controls the display controller 22 to turn off the screen display and controls the operation determinator 24 to set the touch screen to reject any operation of the touch screen.

The information processing apparatus 11 requests the user to perform an authentication process for unlocking the locked state. In step S 1, the controller 21 determines whether there is any of sleep canceling operation and screen display turning-on operation or not. When there is one of these operations, the controller 21 controls the display controller 22 to display an authentication screen for requesting the user to perform authentication operation (step S2). Thus, the controller 21 waits for the authentication process. That is, in step S3, the controller 21 waits for user's operation of the rear operation receiver 18.

When operation of the rear operation receiver 18 is performed by the user, the input determinator 26 outputs a determination result of the rear operation to the authentication processor 27. Concealment of operation of the rear operation receiver 18 is high because the rear operation receiver 18 is provided in the rear surface 17 of the housing 12 so that operation of the rear operation receiver 18 can hardly be recognized visually in an ordinary operating state where the touch screen 14 is viewed from above. The authentication processor 27 performs comparison as to whether the determination result of the rear operation coincides with the condition stored in the authentication condition storage 28 or not (step S4). When the user performs operation registered as the authentication condition, the authentication processor 27 determines that the operation matches the authentication condition, and outputs an authentication result that the user is authenticated to the controller 21. Thus, the controller 21 accepts the authentication (step S5).

Upon acceptance of the authentication, the controller 21 requests the lock controller 25 to unlock the locked state. The lock controller 25 controls the display controller 22 to turn on screen display, and controls the operation determinator 24 to restart acceptance of operation of the touch screen. Thus, the locked state is unlocked (step S6).

Thus, in this embodiment, since an authentication-operation receiver is provided in the rear surface of the housing where the touch screen is not provided, the user can perform an authentication process without being noticed by other people so that security can be improved.

Although the example of FIG. 1 shows the case where the rear operation receiver 18 is provided so as to protrude from the rear surface 17 of the housing 12, the rear operation receiver 18 may be provided so that the operation surface of the rear operation receiver 18 does not protrude from the rear surface 17. The rear operation receiver 18 is not limited to the button switch but any other type switch may be used. For example, a touch pad using any type such as a capacitive type or a resistive type may be used as the rear operation receiver 18.

In the case where authentication is accepted when the rear operation receiver 18 is pushed only once, the authentication processor 27, the authentication condition storage 28 and the timer 29 can be dispensed with, and the authentication process can be completed when the output of the input determinator 26 is fed to the controller 21 directly.

### Second Embodiment

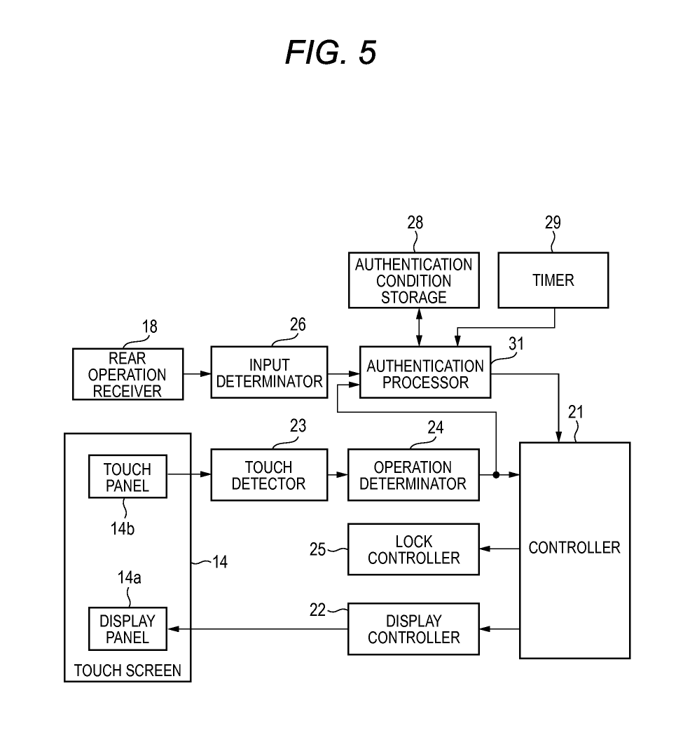

FIG. 5 is a block diagram showing a second embodiment. In FIG. 5, the same constituent parts as those in FIG. 1 are referred to by the same numerals and description thereof will be omitted.

Although the first embodiment has been described in the case where authentication is performed by operation of only the rear operation receiver 18, this embodiment is different from the first embodiment in that authentication is performed by combination of operation of the rear operation receiver 18 and operation of the touch screen 14.

A result determined by the input determinator 26 and a result determined by the operation determinator 24 are given to an authentication processor 31. The authentication condition storage 28 holds an authentication condition having described contents of operations of the rear operation receiver 18 and the touch screen 14 in order to authenticate the user. The authentication processor 31 performs authentication by referring to the authentication condition stored in the authentication condition storage 28 and time information given from the timer 29 and comparing the operation defined in the authentication condition with a result of determination of operations of the rear operation receiver 18 and the touch screen 14.

Examples of authentication operation on the touch screen 14 are swiping operation, image pattern designating operation, authorization code inputting operation, etc. For example, the authentication condition may be defined so that authentication is accepted when a predetermined operation of the touch screen 14 is performed after a predetermined operation of the rear operation receiver 18. Inversely, the authentication condition may be defined so that a predetermined operation of the rear operation receiver 18 is performed after a predetermined operation of the touch screen 14. Alternatively, the authentication condition may be defined so that authentication is accepted when predetermined operations are performed in a predetermined sequence on the rear operation receiver 18 and the touch screen. Alternatively, the authentication condition may be defined so that authentication is accepted when predetermined operations are performed simultaneously on the rear operation receiver 18 and the touch screen 14.

The authentication processor 31 may output part of the authentication result to the controller 21 whenever an authentication operation on the rear operation receiver 18 or an authentication operation on the touch screen 14 in all authentication operations for accepting authentication is performed correctly. In this case, the controller 21 may control the display controller 22 so that a message indicating that the next authentication should be received at the rear operation receiver 18 or the touch screen 14 is displayed on the display screen of the display panel 14a.

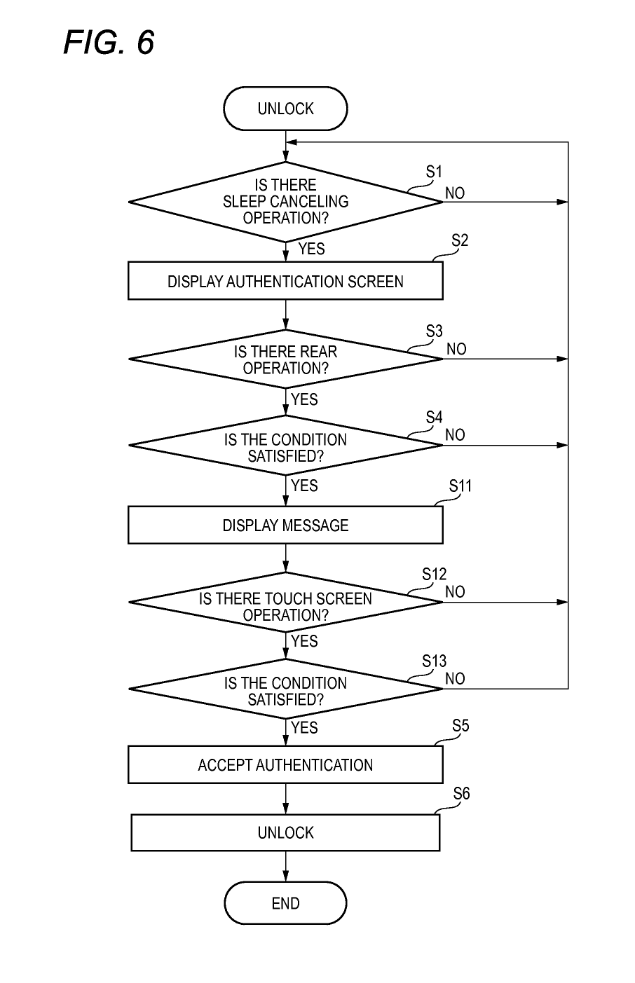

Operation of the embodiment configured in this manner will be described below with reference to a flow chart of FIG. 6. In FIG. 6, the same steps as in FIG. 4 are referred to by the same numerals and description thereof will be omitted. FIG. 6 shows the case where authentication is accepted when an authentication operation on the touch screen 14 is performed after an authentication operation on the rear operation receiver 18, by way of example.

Assume now that the information processing apparatus in FIG. 5 has been already locked in a sleep mode. Assume now that the user is to perform one of sleep canceling operation and screen display turning-on operation. When there is one of these operations, the controller 21 controls the lock controller 25 to control the display controller 22 to display an authentication screen for requesting the user to perform authentication operation and to enable the operation determinator 24 to perform operation determination of the authentication operation on the touch screen 14 in step S2.

When the user performs authentication operation on the rear operation receiver 18, the authentication processor 31 determines whether authentication operation on the rear operation receiver 18 is performed correctly or not (step S4), based on comparison between the result determined by the input determinator 26 and the authentication condition stored in the authentication condition storage 28. When the authentication operation is performed correctly, the authentication processor 31 outputs a determination result indicating that the authentication operation on the rear operation receiver 18 is correct, to the controller 21. The controller 21 controls the display controller 22 so that a message indicating that authentication will be accepted for unlocking by next operation on the touch screen is displayed on the display screen of the display panel 14a.

In the next step S12, the information processing apparatus waits for authentication operation on the touch screen 14 (step S12). When touch operation on the touch screen 14 is performed, the operation determinator 24 determines a swiping operation, an image pattern designating operation, an authentication code inputting operation, etc. based on the result detected by the touch detector 23 and outputs a determination result to the authentication processor 31. The authentication processor 31 determines whether authentication operation on the touch screen 14 is performed correctly or not (step S13), based on comparison between the result determined by the operation determinator 24 and the authentication condition stored in the authentication condition storage 28.

When authentication operation on the touch screen 14 is performed correctly, the authentication processor 31 outputs a determination result indicating that authentication operation is performed correctly, to the controller 21. Consequently, the controller 21 accepts authentication and requests the lock controller 25 to unlock the locked state.

Thus, also in this embodiment, authentication is performed based on operation of the authentication-operation receiver provided in the rear surface of the housing where the touch screen is not disposed, so that concealment of the authentication operation is high. Moreover, in this embodiment, authentication is accepted when both authentication operations on the rear operation receiver and on the touch screen are performed, so that security can be improved more greatly.

### Third Embodiment

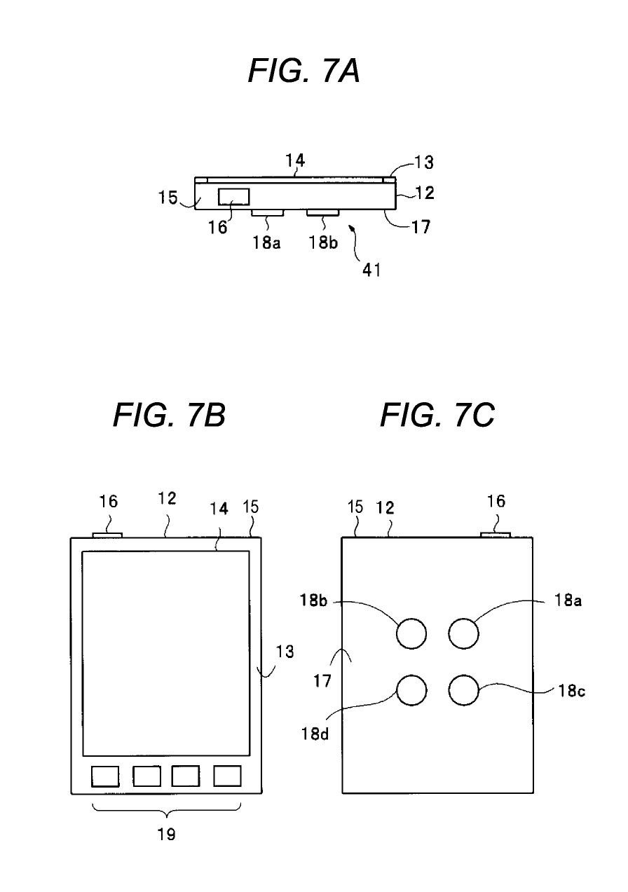

FIGS. 7A to 7C are schematic views showing a third embodiment. FIG. 7A is a top view of the housing. FIG. 7B is a front view showing a front surface of the housing. FIG. 7C is a rear view showing a rear surface of the housing. In FIGS. 7A to 7C, the same constituent parts as in FIG. 1 and FIGS. 2A and 2B are referred to by the same numerals and description thereof will be omitted.

In an information processing apparatus 41 according to this embodiment, four rear operation receivers 18a to 18d are disposed in the rear surface 17 of the housing 12. For example, each of the rear operation receivers 18a to 18d is made of a button switch so that a signal corresponding to user's pushing operation on each of the rear operation receivers 18a to 18d is outputted to the input determinator 26 (see FIG. 3 or FIG. 5).

Although the case where four rear operation receivers 18a to 18d are provided is described in FIGS. 7A to 7C, the number of rear operation receivers is not limited to four. For example, any number of rear operation receivers which can receive user's rear operation may be provided. Although FIGS. 7A to 7C show the case where each of the rear operation receivers 18a to 18d is made of a button switch, any other type switch, a touch pad or a combination of these than the button switch may be used.

The circuit configuration in this embodiment is the same as the circuit configuration in FIG. 3 or 5 except that the input determinator 26 capable of determining a plurality of inputs (e.g. four inputs in FIGS. 7A to 7C) in accordance with the number of the rear operation receivers is used. That is, when this embodiment is applied to the first embodiment corresponding to FIG. 3, the sequence of operation of the four rear operation receivers 18a to 18d, the number of operations, the operating time, etc. can be defined as an authentication condition. For example, the condition that the rear operation receivers 18a to 18d are one-by-one pushed down successively in a predetermined time may be provided as an authentication condition. For example, the condition that the rear operation receivers 18a to 18d are pushed down once, twice, three times and four times respectively and successively in a predetermined time may be provided as an authentication condition.

When this embodiment is applied to the second embodiment corresponding to FIG. 5, the sequence of operation of the four rear operation receivers 18a to 18d, the number of operations and the operating time combined with the operation of the touch screen 14 can be defined as an authentication condition. For example, the condition that the rear operation receiver 18a is pushed down once, swiping operation is then performed on the touch screen 14, the rear operation receiver 18d is then pushed down twice and a star figure is then drawn by sliding operation on the touch screen 14 may be provided as an authentication condition.

In any case, since the rear operation receivers 18a to 18d are provided in the rear surface 17 of the housing 12, it is difficult for other people to confirm operations on the rear operation receivers 18a to 18d so that concealment of authentication operation can be improved. Moreover, it is very difficult for other people to confirm operations on the plurality of rear operation receivers 18a to 18d, so that the security effect is very high.

Also in this embodiment, the same effect as in the first or second embodiment can be obtained and the security effect can be improved more greatly.

Although the second and third embodiments exemplify the case where authentication is accepted when both the touch screen and each rear operation receiver receive authentication operation, operation of the touch screen may be replaced by operation of another operation receiver so that authentication is performed by combination of operation of the other operation receiver and operation of the rear operation receiver. It may be further configured such that authentication is accepted by combination of photographing operation for face authentication or fingerprint authentication and operation of the rear operation receiver.

The invention is not limited to the aforementioned embodiments, and various modifications may be made without departing from the spirit thereof. The aforementioned embodiments include various aspects of inventions, so that various inventions can be extracted by suitably combining the disclosed features. For example, even if some features are removed from all features in each embodiment, the configuration after such removal may still have the same advantages as the abovementioned embodiments.

Each of the embodiments may be achieved by processing based on software using a general-purpose processor without dedicated-purpose hardware(s). For example, each of the embodiments can be achieved by use of a computer program according to FIG. 4 or 6, for example, by bringing the computer program into a computer through a recording medium such as an FD, an MO, a CD-ROM, etc. and then causing the computer to execute it.

1. An information processing apparatus, comprising:
a housing having a first surface and a second surface opposite thereto;
a touch screen provided on the first surface of the housing;
a first operation receiver provided on the second surface of the housing; and
an authentication processor which performs an authentication process based on operation of the first operation receiver.

2. The information processing apparatus of claim 1,
wherein the authentication processor performs the authentication process referring to an authentication condition which defines at least one of the number of operations and a time of an operation to be performed at the first operation receiver.

3. The information processing apparatus of claim 1,
wherein the authentication processor performs the authentication process based on operation of the first operation receiver and the touch screen.

4. The information processing apparatus of claim 1, further comprising:
a second operation receiver provided on another surface than the second surface of the housing,
wherein the authentication processor performs the authentication process based on operation of the first and second operation receivers.

5. The information processing apparatus of claim 1,
wherein the first operation receiver includes a plurality of operation parts, and
wherein the authentication processor performs the authentication process referring to an authentication condition which defines at least one of a sequence of operations, the number of operations and a time of an operation to be performed at the operation parts.

6. The information processing apparatus of claim 5,
wherein the authentication processor performs the authentication process based on operation of the operation parts and the touch screen.

7. An authentication method for an information processing apparatus equipped with a housing having a first surface and a second surface opposite thereto and with a touch screen provided on the first surface of the housing, the method comprising:
detecting operation of a first operation receiver provided on the second surface of the housing; and
performing authentication by comparing the detected operation of the first operation receiver with operation previously defined in a authentication condition.

8. The method of claim 7, further comprising:
detecting operation of the touch screen,
wherein the performing authentication compares the detected operation of the first operation receiver and the detected operation of the touch screen with operations previously defined in the authentication condition.

9. An authentication program for an information processing apparatus equipped with a housing having a first surface and a second surface opposite thereto and with a touch screen provided on the first surface of the housing, the program enabling the information processing apparatus to execute:
detecting operation of a first operation receiver provided on the second surface of the housing; and
performing authentication by comparing the detected operation of the first operation receiver with operation previously defined in a authentication condition.

10. The program of claim 9, further enabling:
detecting operation of the touch screen,
wherein the performing authentication compares the detected operation of the first operation receiver and the detected operation of the touch screen with operations previously defined in the authentication condition.
